(19) United States
(12) Patent Application Publication
(10) Pub. No.: US 2005/0102630 A1
(43) Pub. Date: May 12, 2005

(54) Meta window for merging and consolidating multiple sources of information

(75) Inventors: Yen-Fu Chen, Austin, TX (US); John W. Dunsmoir, Round Rock, TX (US)

Correspondence Address: IBM CORPORATION (RHF), C/O ROBERT H. FRANTZ, P. O. BOX 23324, OKLAHOMA CITY, OK, 73123, US

(73) Assignee: International Busainess Machines Corporation, Armonk, NY (US)

(21) Appl. No.: 10/703,018

(22) Filed: Nov. 6, 2003

(51) Int. Cl. G06F 3/00; G06F 17/24

(52) U.S. Cl. 715/770; 715/769; 715/523; 715/524

(57) ABSTRACT

Content is transferred from a plurality of designated resources to a Meta Window where the information elements from those resources are consolidated and presented to a user. The user may manipulate the information elements individually or in groups, refresh them from their traced sources, undo manipulations previously performed, and transfer the manipulated information to a destination computer resource. The user interfaces to the source computer resources are preferably locked and minimized after they have been designated as a source until the transfer to the destination is completed. Optionally, the invention provides a drag-and-drop operation which allows the user to drag icons representing the sources onto an icon for the Meta Window, thereby causing automatic consolidation of their information elements with minimal user effort.

### CROSS-REFERENCE TO RELATED APPLICATIONS (CLAIMING BENEFIT UNDER 35 U.S.C. 120)

This application is related to U.S. Patent application Ser. No. 10/455,159, docket number AUS920030289US1, filed on Jun. 5, 2003, by Yen-Fu Chen.

### FEDERALLY SPONSORED RESEARCH AND DEVELOPMENT STATEMENT

This invention was not developed in conjuction with any Federally sponsored contract.

### MICROFICHE APPENDIX

Not applicable.

### INCORPORATION BY REFERENCE

The related patent application, U.S. Patent application Ser. No. 10/455,159, docket number AUS920030289US 1, filed on Jun. 5, 2003, by Yen-Fu Chen, is incorporated by reference, in its entirety including figures, to the present patent application.

### BACKGROUND OF THE INVENTION

1. Field of the Invention

This invention relates to the arts of computer user interfaces and data exchange between program entities such as instances of programs in a multi-tasking computer system. This invention relates especially to computer methods for transferring information from multiple sources into a single user interface which allows the content to be managed, edited, and manipulated before delivering it to one or more destinations.

2. Background of the Invention

Modem multi-tasking computers provide a variety of user interfaces for controlling multiple application programs and system functions which operate simultaneously. Some of the most widely used multi-tasking computer systems are personal computers (“PC”) running a multi-tasking operating system (“OS”) such as International Business Machines' (“IBM”) OS/2 [TM] or AIX [TM, Microsoft Windows [TM], and Apple Computer's MacOS [TM]. Other operating systems may be used with personal computers as well as larger computers such as enterprise-class computers, such as UNIX, Sun Microsystems' Solaris [TM], Hewlett Packard's HP-UX [TM], and the “open sourced” LINUX. Smaller computing platforms such as held-held computers, personal digital assistants (“PDA”), and advanced wireless telephones may run operating systems targeted for such hardware including Palm Computing's PalmOS [TM] and Microsoft's Windows CE [TM]. Additionally, there are many “proprietary” and less widely-used computing platforms and operating systems which also allow users to control and run multiple programs and system functions simultaneously.

Many of these systems will use tabs, icons, windows, frames, pages and special key combinations to allow a user to switch between user interfaces (“UI”) for each program and system function which is being executed, or to start or stop the execution of a program or system function. For example, in a personal computer running MS Windows [TM], the user may first start a web browser program running using several methods (e.g. double clicking an icon on the desktop, selecting the program from a Start Programs list, operating a “hot key”, etc.), and then may start a document editor program using similar methods. Each program establishes a user interface such as its own “window”. The user can then control a program by selecting its window using one of several available methods, such as selecting a button or icon on a command bar, activating a “task list” and selecting a program, etc. As a result, a user can start and run many programs simultaneously, periodically switching between their user interfaces to accomplish work or entertainment tasks as needed. Other computing systems provide similar basic user control capabilities, albeit with a variety of user controls to switch between programs and system functions.

Users often wish to copy or transfer information or “content” from one program or system function to another. For example, a user may be preparing an invoice for a client using a word processor program, but may also be simultaneously using a database or spreadsheet program to perform various calculations. Using “copy and paste” functions of the application programs and the operating system, the user may select information from a source program (e.g. the spreadsheet), and “paste” it into the destination program (e.g. the invoice being edited). Such a process is so common place in computer users' daily lives that it is rote, albeit each user may know several sequences of actions for several computers which he or she commonly uses (e.g. one process on his home PC, another on his PDA, and another on his networked terminal at work). These memorized methods may typically include several steps of clicking on icons, dropping down lists, highlighting information, and using navigation controls within program UI's.

For example, turning to FIG. 1, a “windows” style user interface is depicted to illustrate a process of “copying” information from a web browser program to a word processor file via a “clipboard” memory. In this system, each program provides a window (2, 3, 104) which can be closed (9, 9′) to end the program, maximized (8, 8′) to view the full UI for that program, or minimized (7, 7′) to leave the program running but deactivate the UI (e.g. clear the UI window from the screen). In this example, these controls are located in a command bar (4, 4′) along the top of the UI window, but many other variations are known in the art.

Each UI window also typically has navigation controls such as left panning (15, 15′), right panning (13, 13′), and horizontal scroll (14, 14′) controls, as well as up panning (10, 10′), down panning (12, 12′), and vertical scroll (11, 11′), for viewing areas of information and content not completely viewable in the UI. Information, icons, text, graphics, etc., are shown or displayed within (16, 18) the UI window according to the scroll and panning control settings. More recently, the term “content” (16, 18) has been used to collectively refer to all types of information which may be displayed or presented in a user interface, including but not limited to text, graphics, still images, animated images, video, audio, and hyperlinks.

Now suppose for the purpose of our example, the user has started a word processing program which provides a first UI window (2), and a web browser which provides a second UI window (3). Also suppose that the user is researching information on the Internet using the web browser while authoring a paper which is being edited simultaneously using the word processor.

In this example, the user has found information (19) at a hypothetical web address (17) that he wants to “quote” in his or her paper. So, the user must first move the cursor (104) in the word processor to select an insertion point for the information, then must switch to the web browser UI, select the text (19) in the source content, operate a “copy” command in the web browser UI which copies (101) the content into a buffer (100) such as a “clipboard”, switch back to the word processor UI, and operate a “paste” or “insert” command, which results in the copied content (19) being inserted into the destination document at the point of insertion (103). The user can repeat this process for many different program UI's (106).

In some software and hardware configurations, the copy buffer may be provided within a suite of application programs which are “tightly coupled” or related. Such suites cooperate with each other in ways not possible with software programs provided by differing suppliers. In many cases, however, the operating system provides a buffer function which is generally accessible by all programs, such as the clipboard in the MS Windows [TM] operating system.

Also, in some situations, the original content with its original format may not be acceptable by the destination program, and as such, a specialized paste or insertion function (105) may be provided by the destination program or operating system which converts the content to a form useful by the destination program. For example, text copied from a web page may include color, size, font, style, and hyperlink reference information embedded in the base Hyper Text Markup Language (“HTML”) of the source web page. However, not all word processors are able to interpret all of these special codes and identifiers, so a “paste as plain text” option may be provided by a converter or translator (105) function.

So, to illustrate the complexity and tedious nature of such ordinary operations, we present the steps in full to accomplish this example scenario of simply transferring a block of formatted text from a web page to a word processor program, starting from a point where the user is editing the destination document in the word processor:
(a) navigate to the insertion point in the destination document using the word processor UI window controls (e.g. multiple clicks on scroll, panning or page up/page down keys);
(b) optionally select text or content in the destination document which is to be replaced;
(c) switch to the web browser UI window (e.g. click on an icon in a task bar, activate a task list and pick a running web browser program, etc.);
(d) navigate in the web browser UI window to find the text or content desired to be transferred into the document (e.g. use panning, scrolling, or page up/page down keys);
(e) select the source content or text (e.g. click-and-drag over the content to highlight it)
(f) transfer the content to a copy buffer (e.g. click on “Edit” command, select “copy” option or type Alt-E, Alt-C);
(g) switch back to the word processor UI window (e.g. (e.g. click on a icon in a task bar, activate a task list and pick a running web browser program, etc.); and
(h) operate a “paste” command in the word processor UI window (e.g. click on “Edit” command, select “paste” option or type Alt-E, Alt-P).

Each of these operations may actually require several steps (clicking, scrolling, selecting, typing, etc.), so this minimal process may represent 7 to 25 actual user actions. This process must be repeated for each block of text or content to be transferred from multiple program UI windows (106), and additional steps may be necessary to achieve a “special paste”, as described above. Also, if the same text or content is to be inserted into the destination document for file at multiple locations, the last few operations of this process (h) in addition to some navigation actions must by performed by the user.

As a result, consolidating information from multiple sources of information may be extremely tedious, frustrating, and tiresome using the currently available methods and apparatuses provided in such computing systems. Some systems may provide notably more “user friendly” or intuitive methods, while other systems are much more difficult and “clunky” to use.

Turning to FIG. 2, this process is generalized. Starting at a point or time (21) when the user is actively working with the destination program UI, the user must navigate (22) within the present document, file, or other computer resource to a point where the content insertion is to be made, including selecting any content which is to be replaced. Then, the user must switch (23) to the UI of the first source of information, navigate (24) to the first source content to be transferred, select that content, and operate (25) a copy or cut control in the first source UI.

Next, the user must switch (26) back to the destination UI, and operate (27) an insert or paste command in that UI. If (28) the user wants to insert or paste that content into multiple destinations, the user must navigate (29) to each destination and operate (27) the paste or insert command in the destination program UI, until all insertions have been made for that source information.

If (200) the user desires to transfer information from other points in the same source, or from other sources, the user must repeatedly switch (201) to a source UI, navigate to a source content point, select source information, operate (25) a copy or cut operation, switch (26) back to the destination UI, and paste or insert (27) the content, until all information has been transferred.

Implied, but not shown in detail, in this generalization of the process can be multiple user actions for each general step. Optionally, options such as conversion of the content may be necessary, which requires additional user actions (e.g. the “paste as plain text” example).

So, it is not inconceivable that in the course of authoring a paper using a word processor and information from several sources, the user may have to perform hundreds of tedious actions, commands, selections, navigation operations, etc.

In this paradigm, certain conventions have evolved into place which only moderately simplify or reduce the burden of such operations. For example, performing a “cut” operation usually deletes the selected source content from the source file, and places a copy of it into the transfer buffer, sometimes overwriting the current contents of the transfer buffer. A “copy” operation typically leaves the selected information unchanged in the source and only places a copy of the information in the transfer buffer. Additionally, in the destination UI, a “paste” or “insert” command may copy the contents of transfer buffer to a selected point in the destination document or file, leaving a copy in the transfer buffer for additional pastes or insertions.

In some programs, a “paste special”, “import from clipboard”, or similar command may be available with several conversion options to perform a minimal conversion process on each transfer. However, even though the user may be performing the same “paste special” command over and over, the typical UI does not memorize or “learn” this process, so the user is forced to respond to a number of redundant options and dialogs on each paste operation.

The same user interface conventions are followed by many computer systems not only for content or information within a computer resource such as text and graphics within a file, but also for resources (e.g. files, shortcuts, icons, mappings, etc.) within a computing environment (e.g. file system, directories, folders, etc.). For example, when working with a MS Windows [TM] operating system and running the Windows Explorer program, a user may select a file, directory or folder to move, execute an “Edit—Cut” command sequence, navigate to another directory or drive, and execute an “Edit—Paste” command to move the selected resource to the new destination. Similarly, by selecting the source resource, executing a copy command, and then executing a paste command to one or more destinations, the original resource is not changed but copies of it are deposited at the destination points. Further, by selecting and copying a source resource, then selecting a destination resource, replacement of the destination resource may be accomplished.

The invention described in the related patent application entitled “System and Method for Content and Information Transfer Between Program Entities”, filed by Yen-Fu Chen, et al., and incorporated herein, addressed this problem to a large degree. The related invention enables users to preselect or pre-designate one or more destination content area(s) or points, and then to only perform the highlighting action in the source files or documents to produce copy/paste results without any additional mouse clicks or touching the keyboard.

According to one aspect of the related invention, the user initially designates one or more insertion points or replacement areas for receiving transferred content in a destination UI, then switches to a source UI, highlights content to be transferred, and the system performs the copy or paste operation without any additional user action, including any conversion as may be necessary.

Then, the user may simply navigate to another point in the same source, or switch to another source UI, select content, and it will be “pasted” automatically into the destination without the user having to switch back to the destination UI or perform any additional paste or insert command actions.

However, this arrangement depends on a designated destination application or document to be the point of consolidation of information from the source applications and documents. For example, if a user is creating a new document (59) using the Lotus WordPro word processor program, and there is a need to consolidate information from a Microsoft Excel [TM] spreadsheet (52), and image (53) from Corel Photohouse [TM] image editor, and a portion of a web page (56) with an associated graphic image being viewed with Netscape Navigator web browser program, as shown in FIG. 5.

In this figure, each arrow leading from a source document to the clipboard or paste buffer (500) represents an user action to switch to the appropriate application user interface (51, 52, 55) such as an Alt-Tab key combination in MS Windows, highlighting the desired content to be copied to the new document such as by clicking-and-dragging with a mouse, and executing a copy or cut operation such as by selecting Edit and Copy from a drop down list in the source application GUI (51, 53, 55). Each of these groups of operations, then, potentially involves 4 or more user actions.

Each “pasting” operation is represented by an arrow leading from the clipboard or paste buffer (500) into the new document (59). A paste operation includes switching back to the destination application user interface (57) such as by Alt-Tab key combination, then selecting a point for insertion in the new document (59) such as by clicking in the document with a mouse, and then executing a paste operation such as by selecting Edit and Paste from a drop down list in the destination application GUI (57). Each of these paste operation represents 4 or more user actions.

To further complicate matters, each application GUI may use slightly different actions to perform a cut, copy or paste. As such, just to consolidate information from three sources into one destination, 24 or more user actions may be required.

Using the invention described in the related application, this effort can be significantly reduced by allowing the user to first designate a single insertion point in the destination document, and then to visit each source and select information to be automatically transferred to the destination without returning to the GUI for the destination until all the sources have been designated.

This, though, effectively concatenates all of the selected information into one long series of information elements in the source document. Consider the following example. The user first transfers the table of numbers:

| Name | Age | Miles Driven |
|---|---|---|
| Bob | 23 | 1023 |
| Jane | 44 | 925 |
| Hal | 58 | 2041 |

from the spreadsheet to the new document. Next, the user transfers an image, which we will refer to as <Map_Image>, from Corel Photohouse to the new document. Finally, the user transfers the following text and image from a web page:
“Our three drivers celebrate the conclusion of their trip to see all of the sites where Elvis Presley ate peanut butter sandwiches in public.” <Group_Photo>

to the new document. In such a case, the user would then return to the GUI for editing the new document, where the following content would appear:

| Name | Age | Miles Driven |
|---|---|---|
| Bob | 23 | 1023 |
| Jane | 44 | 925 |
| Hal | 58 | 2041 |

<Map_image>
“Our three drivers celebrate the conclusion of their trip to see all of the sites where Elvis Presley ate peanut butter sandwiches in public.” <Group_Photo>

The information elements (e.g. the table, images, and paragraph) are now individually editable, and may be moved, edited, changed, deleted, etc., at will.

In many instances, though, it is desirable to maintain the relationship between the information elements for convenience of manipulation, and for source tracking. For example, the <Group_Photo> is associated originally with the web page and the paragraph “Our three drivers . . . ”. As such, it may be desirable to manipulate them together (e.g. moves, deletes, updates, etc.) in the new document. Additionally, the threes lines of the table are logically associated with each other, and it may be desirable to keep them together while editing the new document.

Unfortunately, though, when the content is “pasted” using the convention means provided by most operating systems and application suites the information elements are not maintained in a logical association with each other.

Therefore, there is a need in the art for a user interface and tool which provides a way for a user to see the contents of a transfer buffer (e.g. clipboard) taken from multiple information sources, manage and change the buffer contents in a manner which maintains logical association of information elements with respect to their sources, and then to deliver that managed and manipulated information to a destination of the user's choice.

### SUMMARY OF THE INVENTION

The present invention provides a Meta Window which allows a user to see, hear, and/or watch the contents of a transfer buffer which contains information elements (e.g. text, paragraphs, images, sound clips, etc.) taken from multiple sources. The user may manipulate, edit, and rearrange the information elements prior to delivering it to one or more destinations. The Meta Window provides a convenient place (e.g. a single user interface) where all information elements copied from multiple sources can be better organized, either as information elements consolidated into the Meta Window, or as a set of sub-windows organized inside the Meta Window. As such, the present invention's advantages apply not only to auto-paste operations, but extend to advanced operations for combining and managing information such as text, images, video, audio, etc.

According to one aspect of the invention, the user initially designates one or more insertion points or replacement areas for receiving transferred content in a destination user interface (“UI”), then switches to a first source UI. The user then designates the first source as a Meta Window source, such as by selecting a menu option or icon. The user then navigates to a second source UI, designating it also as a source, and subsequently to additional source UI's, if needed. The Meta Window is automatically invoked following designation of the second source UI, and the entire contents of each source document or file are copied into the Meta Window.

After designating all of the source documents and files, the user may navigate to the Meta Window, conveniently perform manipulation of the content such as re-arrangement of the content, and finally transfer the final content to the designated destination. This allows the user to deal with the multiple source information elements while within a single user interface environment, e.g. the Meta Window environment, which is more convenient and efficient than navigating among multiple source UI's as previously allowed by the related invention.

The Meta Window maintains logical association between information elements with respect to their sources, such as all elements from a first word processor are logically grouped and manipulated together, all elements from an image editor are logically grouped and manipulated together, and so forth. This logical association can be conveyed to the user in a manner which is intuitive to understand, such as a paragraph of text and an image from a single source may be shown with a green dotted line encompassing them together, and a table of text having several lines of information taken from another single source may have a red dotted line encompassing the entire table. Optionally, the source may be identified with each group of logically associated elements using fly over text or a small marker or tag element, or may be indicated as a group by placing them in graphical elements which appear to be sub-windows within the Meta Window.

When the user has completed reviewing and manipulating the contents of the transfer buffer, the consolidated or merged information can be delivered to a selected destination such as a web page file, word processor file, etc.

According to one aspect of the present invention, the user can simply consolidate sources into the Meta Window by dragging icons which represent each source file or element onto an icon representing the Meta Window.

According to another aspect of the present invention, the user may elect to have links, such as Object Linking Environment (“OLE”) links created for each information element to its source, and a user option may be activated to automatically “refresh” or update the consolidated information by retrieving newer information elements from the same source, if available.

According to yet another aspect of the present invention, the Meta Window maintains a list of manipulation actions performed by the user, and allows the user to “undo” or reverse any or all of the manipulation actions previously performed.

According to an optional embodiment, each group of logically associated information elements may be indicated as a group by placing them in graphical elements which appear to be sub-windows within the Meta Window.

### BRIEF DESCRIPTION OF THE DRAWINGS

The following detailed description when taken in conjunction with the figures presented herein provide a complete disclosure of the invention.

FIG. 1 illustrates the typical user interfaces and system actions of “cutting and pasting” information from one application program to another.

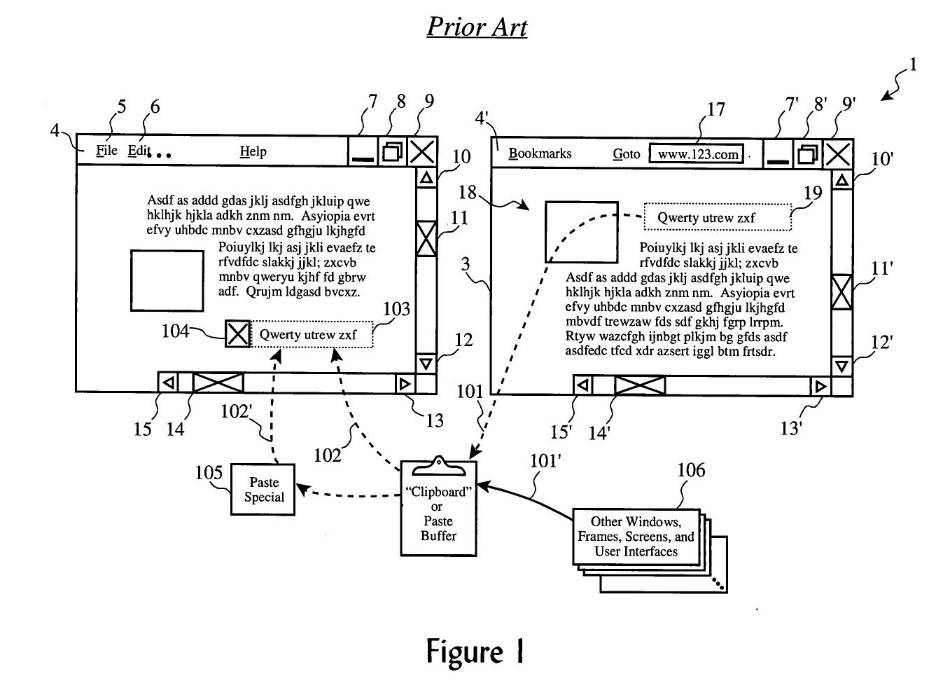

FIG. 2 shows the typical logical process in a general manner for transferring content from one application program or system function to another.

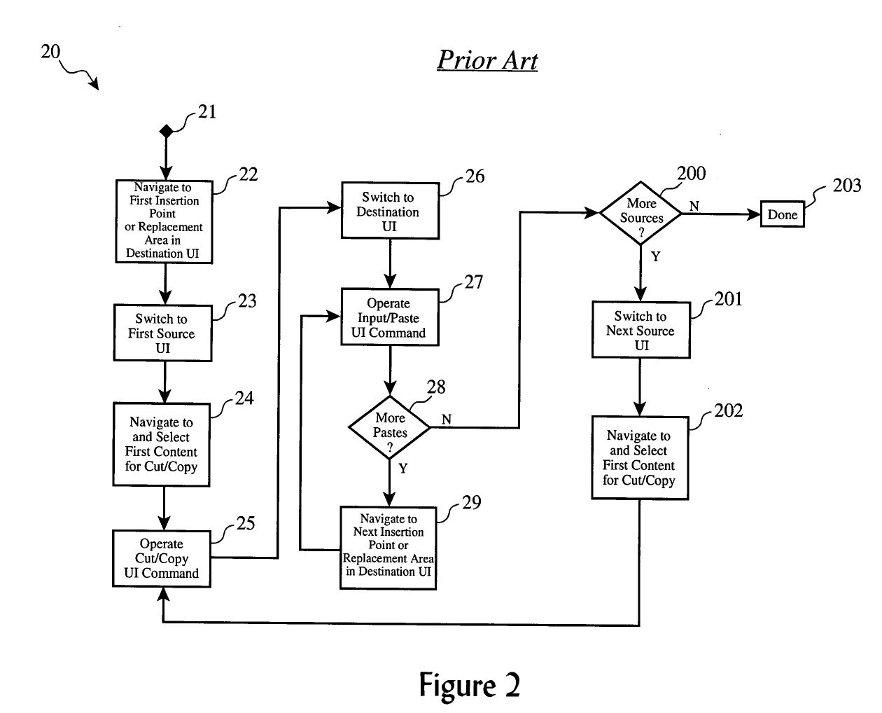

FIG. 3 depicts a generalized computing platform architecture, such as a personal computer, server computer, personal digital assistant, web-enabled wireless telephone, or other processor-based device.

FIG. 4 shows a generalized organization of software and firmware associated with the generalized architecture of FIG. 1.

FIG. 5 illustrates a process of consolidating information from 3 sources into a new document.

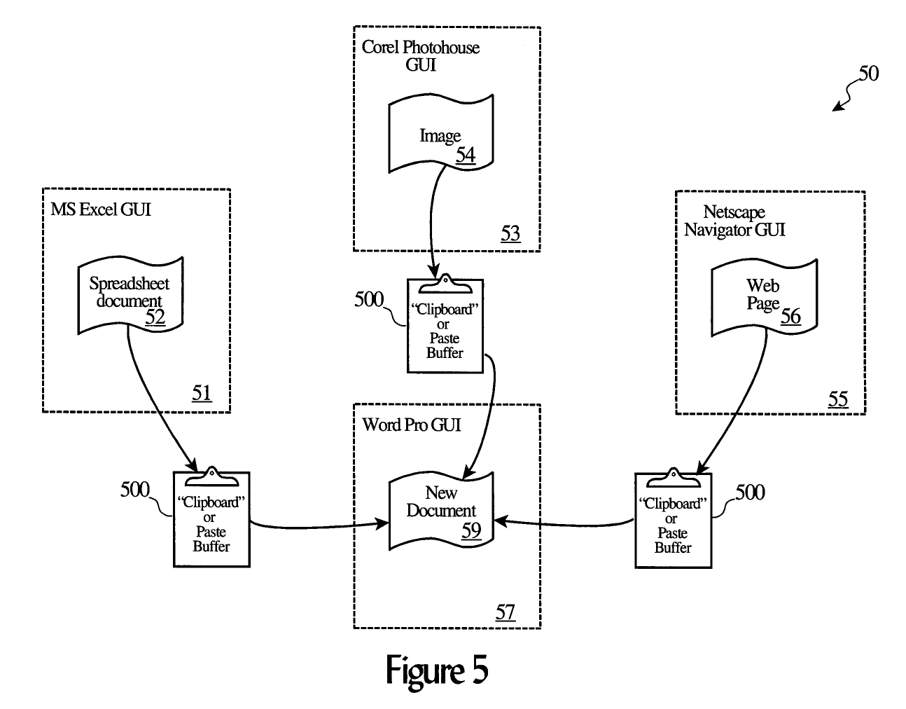

FIG. 6 illustrates a logical process according to the present invention.

FIG. 7 shows an example graphical display of consolidated information in the Meta Window.

FIG. 8 shows a “clean” display option of consolidated information in the Meta Window.

FIG. 9 illustrates a rearranged set of information elements as seen in the Meta Window.

FIG. 10 depicts the drag-and-drop operation for consolidating information into the Meta Window according to an enhanced embodiment of the present invention.

FIG. 11 illustrates an enhanced embodiment of the Meta Window GUI which provides a sub-window for each logical group of information elements.

### DESCRIPTION OF THE INVENTION

The present invention is preferably realized as an enhancement of the related invention, but may be alternately realized in some embodiments as a stand alone tool or as an improvement to other products and application program. As such, the present invention will be described in detail relative to the details of the related invention. It is within the skill of those in the art to adapt the present invention to other embodiments, when provided with the description contained herein.

Suitable Computing Platforms

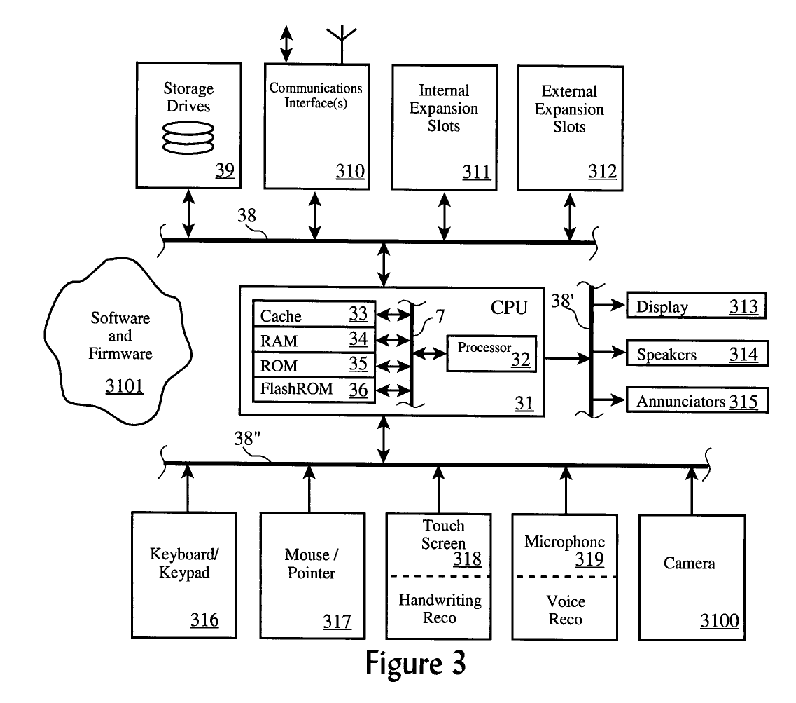

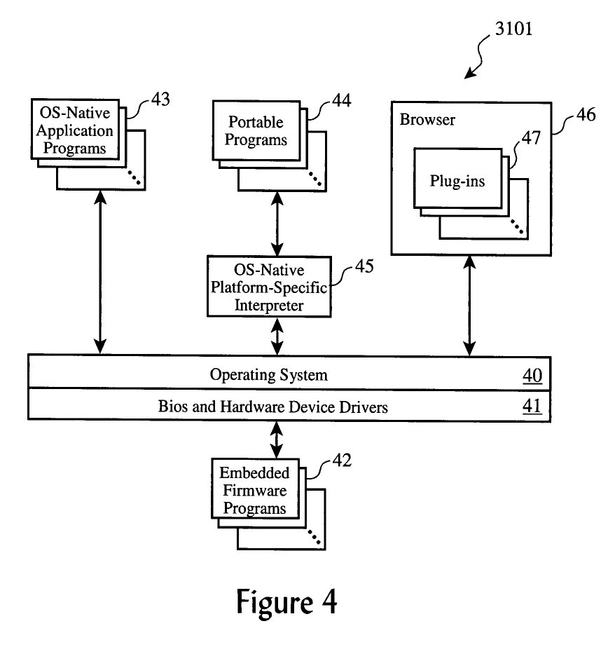

The present invention is preferably realized as computer-executable code such as compiled software, scripts, or portable programs, in conjunction with existing application programs, operating systems, and computer hardware. For purposes of completeness, we first present a generalized view in FIGS. 3 and 4 of typical computer hardware and software which is suitable for realization of our invention. Many variations of these computer platform details may be made without departing from the scope of the invention, as will be readily recognized by those skilled in the art.

Common computing platforms such as personal computers, web servers, and web browsers, as well as proprietary computing platforms, may be used in realization of the present invention. These common computing platforms can include, but are not limited to, personal computers as well as portable computing platforms, such as personal digital assistants (“PDA”), web-enabled wireless telephones, and other types of personal information management (“PIM”) devices.

Therefore, it is useful to review a generalized architecture of a computing platform which may span the range of implementation, from a high-end web or enterprise server platform, to a personal computer, to a portable PDA or web-enabled wireless phone.

Turning to FIG. 3, a generalized architecture is presented including a central processing unit (31) (“CPU”), which is typically comprised of a microprocessor (32) associated with random access memory (“RAM”) (34) and read-only memory (“ROM”) (35). Often, the CPU (31) is also provided with cache memory (33) and programmable FlashROM (36). The interface (37) between the microprocessor (32) and the various types of CPU memory is often referred to as a “local bus”, but also may be a more generic or industry standard bus.

Many computing platforms are also provided with one or more storage drives (39), such as hard-disk drives (“HDD”), floppy disk drives, compact disc drives (CD, CD-R, CD-RW, DVD, DVD-R, etc.), and proprietary disk and tape drives (e.g., Iomega Zip [TM] and Jaz [TM], Addonics SuperDisk [TM], etc.). Additionally, some storage drives may be accessible over a computer network.

Many computing platforms are provided with one or more communication interfaces (310), according to the function intended of the computing platform. For example, a personal computer is often provided with a high speed serial port (RS-232, RS-422, etc.), an enhanced parallel port (“EPP”), and one or more universal serial bus (“USB”) ports. The computing platform may also be provided with a local area network (“LAN”) interface, such as an Ethernet card, and other high-speed interfaces such as the High Performance Serial Bus IEEE-1394.

Computing platforms such as wireless telephones and wireless networked PDA's may also be provided with a radio frequency (“RF”) interface with antenna, as well. In some cases, the computing platform may be provided with an infrared data arrangement (IRDA) interface, too.

Computing platforms are often equipped with one or more internal expansion slots (311), such as Industry Standard Architecture (ISA), Enhanced Industry Standard Architecture (EISA), Peripheral Component Interconnect (PCI), or proprietary interface slots for the addition of other hardware, such as sound cards, memory boards, and graphics accelerators.

Additionally, many units, such as laptop computers and PDA's, are provided with one or more external expansion slots (312) allowing the user the ability to easily install and remove hardware expansion devices, such as PCMCIA cards, SmartMedia cards, and various proprietary modules such as removable hard drives, CD drives, and floppy drives.

Often, the storage drives (39), communication interfaces (310), internal expansion slots (311) and external expansion slots (312) are interconnected with the CPU (31) via a standard or industry open bus architecture (38), such as ISA, EISA, or PCI. In many cases, the bus (38) may be of a proprietary design.

A computing platform is usually provided with one or more user input devices, such as a keyboard or a keypad (316), and mouse or pointer device (317), and/or a touch-screen display (318). In the case of a personal computer, a full size keyboard is often provided along with a mouse or pointer device, such as a track ball or TrackPoint [TM]. In the case of a web-enabled wireless telephone, a simple keypad may be provided with one or more function-specific keys. In the case of a PDA, a touch-screen (318) is usually provided, often with handwriting recognition capabilities.

Additionally, a microphone (319), such as the microphone of a web-enabled wireless telephone or the microphone of a personal computer, is supplied with the computing platform. This microphone may be used for simply reporting audio and voice signals, and it may also be used for entering user choices, such as voice navigation of web sites or auto-dialing telephone numbers, using voice recognition capabilities.

Many computing platforms are also equipped with a camera device (3100), such as a still digital camera or full motion video digital camera.

One or more user output devices, such as a display (313), are also provided with most computing platforms. The display (313) may take many forms, including a Cathode Ray Tube (“CRT”), a Thin Flat Transistor (“TFT”) array, or a simple set of light emitting diodes (“LED”) or liquid crystal display (“LCD”) indicators.

One or more speakers (314) and/or annunciators (315) are often associated with computing platforms, too. The speakers (314) may be used to reproduce audio and music, such as the speaker of a wireless telephone or the speakers of a personal computer. Annunciators (315) may take the form of simple beep emitters or buzzers, commonly found on certain devices such as PDAs and PIMs.

These user input and output devices may be directly interconnected (38′, 38″) to the CPU (31) via a proprietary bus structure and/or interfaces, or they may be interconnected through one or more industry open buses such as ISA, EISA, PCI, etc.

The computing platform is also provided with one or more software and firmware (3101) programs to implement the desired functionality of the computing platforms.

Turning to now FIG. 4, more detail is given of a generalized organization of software and firmware (3101) on this range of computing platforms. One or more operating system (“OS”) native application programs (43) may be provided on the computing platform, such as word processors, spreadsheets, contact management utilities, address book, calendar, email client, presentation, financial and bookkeeping programs.

Additionally, one or more “portable” or device-independent programs (44) may be provided, which must be interpreted by an OS-native platform-specific interpreter (45), such as Java [TM] scripts and programs.

Often, computing platforms are also provided with a form of web browser or microbrowser (46), which may also include one or more extensions to the browser such as browser plug-ins (47).

The computing device is often provided with an operating system (40), such as Microsoft Windows [TM], UNIX, IBM OS/2 [TM], LINUX, MAC OS [TM] or other platform specific operating systems. Smaller devices such as PDA's and wireless telephones may be equipped with other forms of operating systems such as real-time operating systems (“RTOS”) or Palm Computing's PalmOS [TM].

A set of basic input and output functions (“BIOS”) and hardware device drivers (41) are often provided to allow the operating system (40) and programs to interface to and control the specific hardware functions provided with the computing platform.

Additionally, one or more embedded firmware programs (42) are commonly provided with many computing platforms, which are executed by onboard or “embedded” microprocessors as part of the peripheral device, such as a micro controller or a hard drive, a communication processor, network interface card, or sound or graphics card.

As such, FIGS. 3 and 4 describe in a general sense the various hardware components, software and firmware programs of a wide variety of computing platforms, including but not limited to personal computers, PDAs, PIMs, web-enabled telephones, and other appliances such as WebTV [TM] units.

General Logical Process of the Invention

We now turn our attention to disclosure of the present invention relative to the processes and methods preferably implemented as software and firmware on such a computing platform. It will be readily recognized by those skilled in the art that the following methods and processes may be alternatively realized as hardware functions, in part or in whole, without departing from the spirit and scope of the invention.

In general, the related invention provides the user the ability to follow this process:
1. Declare destination content area for pasting or insertion in a destination UI;
2. Enable highlighting or selecting content to automatic copy selected information and store it in memory (e.g. buffer/clipboard) for future usage, as well as to automatically insert or paste the selected information into the pre-designated destination area;
3. Switch to source UI's, and simply highlight or select the desired content portion(s) which triggers dynamic insertion/concatenation into the declared content field.
4. Receive an automatic notification that a portion of the highlighted source information is not compatible with the destination; and
5. Define new rule or process for handling the incompatible content such as conversion, isolation and annotation, such that future similar situations are handled automatically according to the user's preferences.

Using the related invention, advantages over presently available methods and user interfaces are:
1. User-friendly: the invention utilizes maneuvering techniques with which users are already familiar, such as double mouse clicks, dragging to highlight, etc.;
2. Convenient: the invention provides a user a new way of selecting destination for paste operations, and offers a quicker way of copy/paste by eliminating keyboard strokes, mouse clicks, navigation and toggling between different program windows and UI's.
3. Intuitive: Users can learn or “discover” that in this new mode, content highlighting triggers copy/paste effortlessly, immediately seeing the results of the highlighting action, and proceeding to experiment with various ways of applying and exploring this invention.
4. Time-Saving: Reduces time to compile information from multiple sources by making copy-paste user interface methods much more efficient.
5. Increases productivity: By reducing fatigue and tediousness in application program user interfaces, users are allowed to produce more accurate results with less effort in less time.

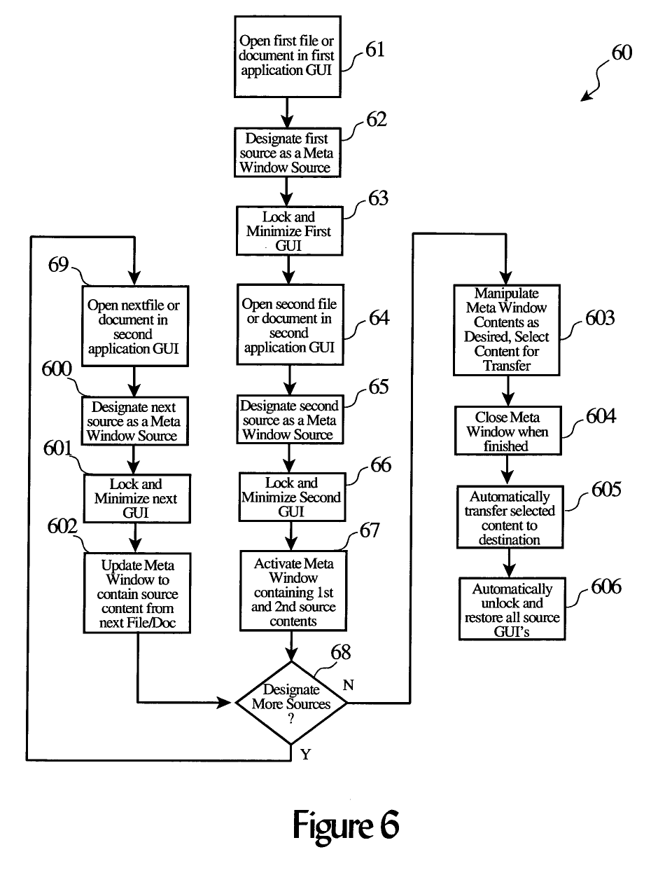

Turning to FIG. 6, a first logical process of the present invention is shown at a high level. This method may be implemented as compiled code, scripts, or interpretable code (e.g. Java, applets, servlets, etc.) in full or part within application programs, operating systems, server suites, utility programs, or proprietary code or hardware.

When creating or editing a new computer resource such as a computer file or document and the user wishes to insert or copy content from multiple sources to the resource being edited, the user may execute the method (60) shown. Prior to executing this process (and not shown), the user navigates to a first insertion point in the new file or document being created, and designates that point to receive the information elements from the Meta Window.

Next, the user navigates (61) to a first source application UI, and designates (62) it as a source for the Meta Window, such as by selecting a menu option or clicking on an icon. The first source application UI is then locked (63) (e.g. user changes and manipulations of content are disallowed), and preferably the UI is minimized, moved to the back of the desktop, or otherwise removed from the screen.

Then, the user navigates (64) to a second source application UI, and designates (65) it as a source for the Meta Window in a similar manner. The second source application UI is then locked (66), and preferably the second UI is minimized, moved to the back of the desktop, or otherwise removed from the screen.

Now that at least two sources have been designated, the Meta Window is displayed (67) at the forefront of the screen or desktop, in which the entire contents of the first source and second source are shown. Also, preferably, the information elements taken from both sources are maintained in logical association with each other with respect to their source, and this relationship is indicated to the user.

If (68) more sources are to be combined in the Meta Window, the user navigates (69) to each additional source UI, designates (600) the additional source as a source to the Meta Window, which locks (and minimizes, preferably) the addition source UI, and copies (602) the entire content of the additional source into the Meta Window (preferably maintaining logical association of information elements).

After all sources have been combined into the Meta Window, the user may then go to the Meta Window GUI, and manipulate (603) the information elements in groups by logical association, or individually. This manipulation may include rearranging the order in which they appear (originally, they are stored in the order they were designated as a source), deleting them, copying them, and changing them.

When the manipulated source information elements are in an acceptable form to the user, the remaining and resultant content in the Meta Window is transferred (605) to the designated destination upon closing (604) of the Meta Window. The locked source UI's are preferably unlocked (606) at this point, and preferably are restored to their original prominence on the user's computer display. Optionally, the system may be configured to leave the source UI's minimized, or to automatically close them.

Action Logs and Undo Functions

As the sources are designated, the invention preferably keeps track of these sources by an action log, such as the one shown in Table 1, which uses the previous example provided in the Background of the Invention for illustration. Here, according to our preferred embodiment, we record the action log in a markup-style language such as XML, but this can be accomplished using a number of other formats (e.g. binary, text, etc.).

TABLE 1
Example Action Log

```
<Meta_Window_action_log>
  <element_group>
    <element_group_source> “miles.xls”</element_group_source>
    <table_element>
      <row>“Name \hat{ }Tab Age \hat{ }Tab Miles Driven </row>
      <row> Bob \hat{ }Tab 23 \hat{ }Tab 1023 </row>
      <row>Jane \hat{ }Tab 44 \hat{ }Tab 925 </row>
      <row> Hal \hat{ }Tab 58 \hat{ }Tab 2041 </row>
    </table_element>
  </element_group>
  <element_group>
    <element_group_source> “Map_image.jpg”
    </element_group_source>
    <graphic_element> Map_image </graphic_element>
  </element_group>
  <element_group>
    <element_group_source> http://www.anypage.com
        </element_group_source>
    <text_element> “Our three drivers celebrate the conclusion of
      their trip to see all of the sites where Elvis Presley ate peanut
      butter sandwiches in public.”
  </text_element>
  <graphic_element> Group_Photo </graphic_element>
</element_group>
</Meta_Window_action_log>
```

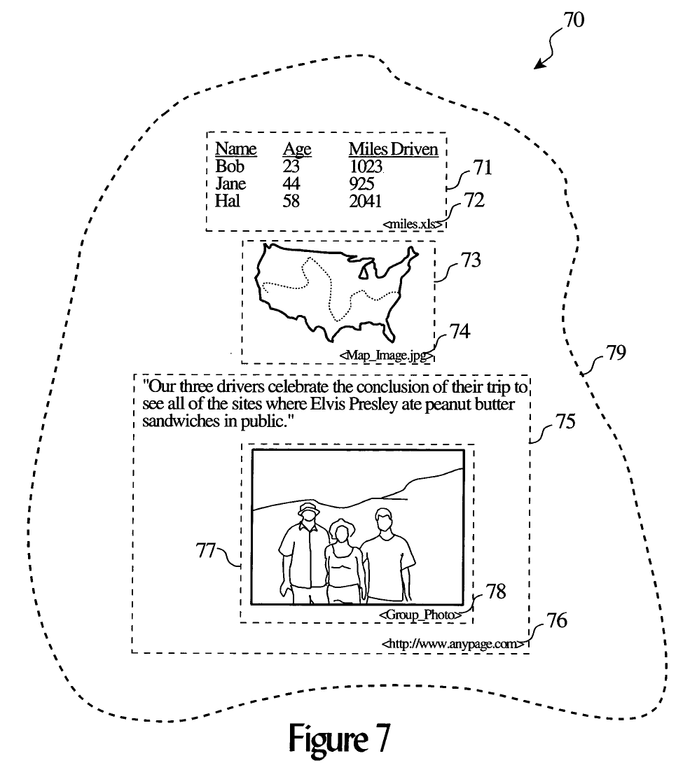

In this action log, which is built during the steps of designating each source, the order of designation is preserved, which represents the order that the information elements will be displayed, preferably along with indicators of logical groups according to the sources from where they were copied. FIG. 7 shows such an example display of these elements.

The initial arrangement (70) of information elements are shown on a portion (79) of a computer display in the Meta Window GUI, in the order in which they were originally designated as sources, e.g. spreadsheet table (71) first, map image (73) second, text and image (75) from web page third, as in our example.

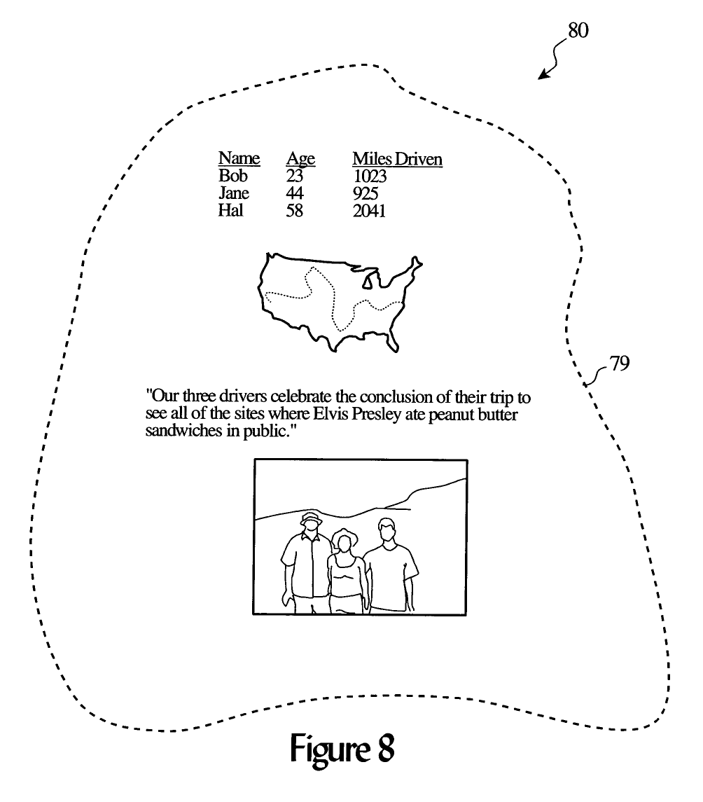

Additionally, the logical grouping of elements are indicated to the user, such as by the display of dotted lines or shaded backgrounds, colors of text, etc., including an indicator of the source of the information elements (72, 74, 76, 78). According to the preferred embodiment, these group indicators can be suppressed (e.g. turned off), as well as the source indicators can be suppressed, to yield a layout (80) such as that shown in FIG. 8 (e.g. a clean layout view).

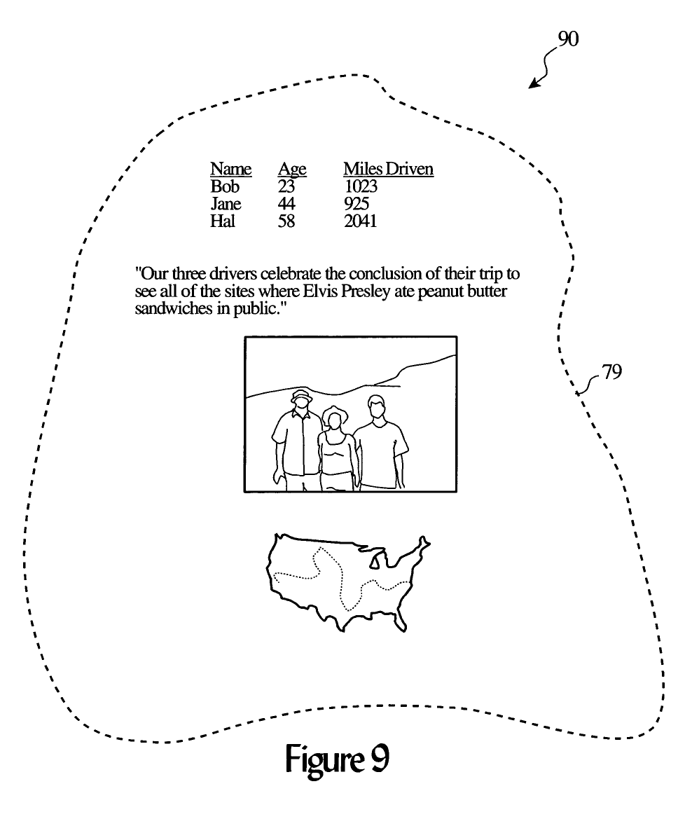

The user can manipulate the information elements, such as changing their order of appearance, using traditional methods within the Meta Window GUI. For example, the user may move the map image to appear last on the page, as the arrangement (90) of information elements shown in FIG. 9. This would result in a change to the action log recording this movement, such as the example given in Table 2.

TABLE 2
Example Re-arranged Action Log

```
<Meta_Window_action_log>
  <element_group>
    <element_group_source> “miles.xls”</element_group_source>
    <table_element>
      <row>“Name \hat{ }Tab Age \hat{ }Tab Miles Driven </row>
      <row> Bob \hat{ }Tab 23 \hat{ }Tab 1023 </row>
      <row> Jane \hat{ }Tab 44 \hat{ }Tab 925 </row>
      <row> Hal \hat{ }Tab 58 \hat{ }Tab 2041 </row>
    </table_element>
  </element_group>
  <element_group>
    <element_group_source> http://www.anypage.com
        </element_group_source>
    <text_element> “Our three drivers celebrate the conclusion of their
      trip to see all of the sites where Elvis Presley ate peanut butter
      sandwiches in public.”
    </text_element>
    <graphic_element> Group_Photo </graphic_element>
</element_group>
  <element_group>
    <element_group_source> “Map_image.jpg”
    </element_group_source>
    <graphic_element> Map_image </graphic_element>
  </element_group>
</Meta_Window_action_log>
```

Further according to the preferred embodiment, a Do-Undo list is maintained by the Meta Window, such that the user can reverse the effect of any operation the user performs. For example, if the user moves an element from its initial position, the Do-Undo list records the movement, including the initial position. If the user selects “Undo—Move”, the element will be automatically restored to its original position. Table 3 shows an example of such a list using the previously described scenario.

TABLE 3
Example Do-Undo List

```
<Meta_Window_Do-Undo>
  <add> miles.xls </add>
  <add> Map_Image.jpg </add>
  <add> http://www.anypage.com </add>
  <group_operation>
    <delete> Map_Image.jpg </delete>
    <add> Map_Image.jpg </add>
  </group_operation>
</Meta_Window_Do-Undo>
```

In this example, the “move” of the map image is accomplished by a two-step operation of deleting the existing occurrence, and then adding it to the end of the list. If the user selects “undo—move” for this map image, the Do-Undo list may be modified in a way as shown in Table 4.

TABLE 4
Example Modified Do-Undo List

```
<Meta_Window_Do-Undo>
    <add> miles.xls </add>
    <add> Map_Image.jpg </add>
    <add> http://www.anypage.com </add>
    <group_operation>
        <delete> Map_Image.jpg </delete>
        <add> Map_Image.jpg </add>
    </group_operation>
    <group_operation>
        <delete> *ALL* </delete>
        <add> miles.xls </add>
        <add> Map_Image.jpg </add>
        <add> http://www.anypage.com </add>
    </group_operation>
</Meta_Window_Do-Undo>
```

In Table 4, one method of restoring or undoing the action is shown in which all the elements are deleted and then are restored to their original order. In alternate embodiments, the list may include element sequence numbers or indicators, and the moved element may be restored to its original sequence number. Other known methods of maintaining reversible lists of action may be employed, as well.

Enhanced Consolidation Operation

According to another aspect of the present invention, the user interface for the Meta Window is enhanced to allow “drag and drop” consolidation of source documents into the Meta Window by selecting an icon or file listing representing a source file with a mouse or pointing device (e.g. stylus, trackball, etc.), dragging the selected item onto an icon or listing for the Meta Window, and dropping them.

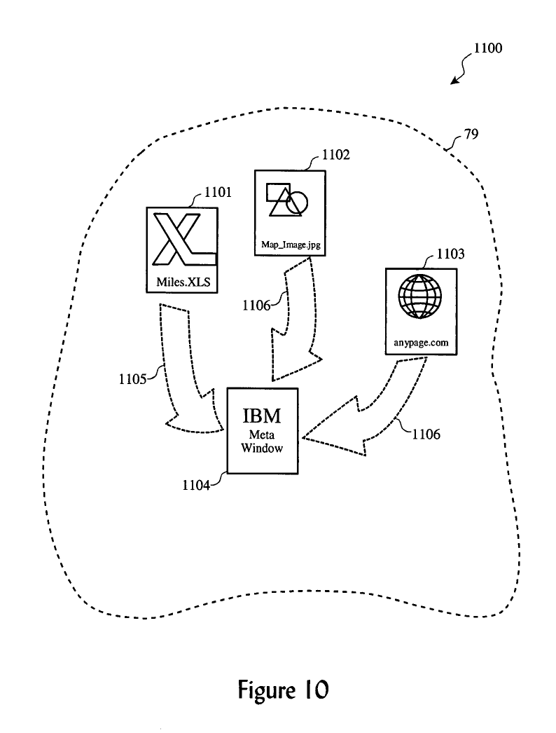

FIG. 10 illustrates such a convenient operation (1100), wherein the icon (1101) for the source MS Excel [TM] file is first dragged and dropped (1105) onto the IBM Meta Window icon (1104). Next, the icon (1102) for the image file is dragged and dropped (1106) on the IBM Meta Window icon (1104). Finally, an icon for the source web page (1103) is dragged and dropped onto the IBM Meta Window icon (1104).

Through use of this enhanced embodiment of the present invention, all switching between application program GUI's is minimized or even eliminated, allowing the user to quickly consolidate the information into the Meta Window, where the user can go straight away to manipulating the information elements as needed.

In an alternate embodiment, a text-style listing of source files and the Meta Window program can be dragged and dropped, as well, such as dragging and dropping text listings in the MS Windows Explorer environment (when the View—Details option is selected).

Enhanced Meta Window GUI with Sub-Windows

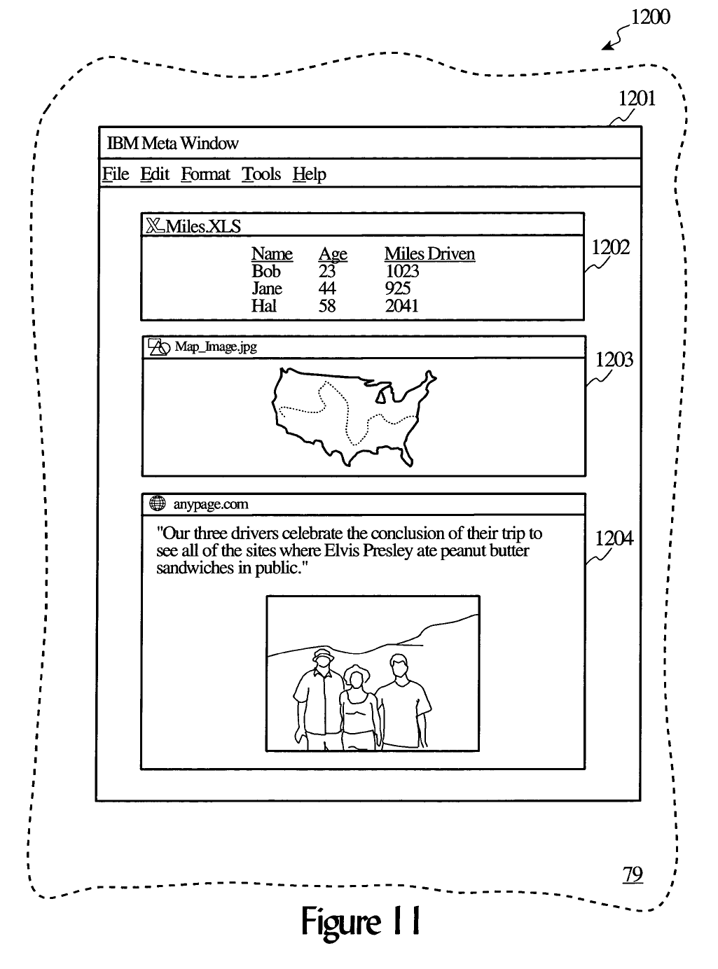

As shown in FIG. 11, an enhanced embodiment (1200) of the present invention includes multiple sub-windows (1202, 1203, 1204) which are displayed within the Meta Window GUI (1201) on a portion (79) of the computer display. In one perspective, this is an enhanced method of showing the logical groupings of information element using a sub-window instead of a simpler encompassing line.

However, the additional functionality gained by using a sub-window to show logical groups of information elements is considerable. For example, if the consolidated information is too extensive to be simultaneously viewable on a single computer screen, then a sub-window allows the user to scroll through viewable areas of the information elements.

Refreshable Consolidation

According to another enhanced embodiment of the present invention, the Meta Window maintains a record of the source of each consolidated group of information elements as previously described (e.g. traces the source), optionally including an Object Linking Environment (“OLE”) link for each group or each element as well.

The Meta Window user interface is enhanced to provide the user with the option of “refreshing” or updating the consolidated information. When this option is selected by the user, the Meta Window consolidates the information as presently available from the recorded sources, and presents the updated information in the Meta Window user interface. The user can then manipulate the information as desired, and then transfer it to the designated destination, thereby updating the destination file or computer resource with the latest available information.

Conclusion

The present invention may be realized in a variety of forms, programming languages, methodologies, and operating systems on a variety of computing platforms without departure from the spirit and scope of the present invention. A number of example embodiment details have been disclosed as well as optional aspects of the present invention in order to illustrate the invention, but which do not define the scope of the invention. Therefore, the scope of the present invention should be determined by the following claims.

1. A method for transferring content from a plurality of source computer resources to a destination computer resource, each computer resource comprising one or more information elements, the method comprising the steps of:
designating of two or more computer resources as source computer resources;
responsive to said designation of two or more source computer resources, providing a Meta Window having a user interface;
consolidating all information elements from said plurality of source computer resources into said Meta Window;
allowing a user to manipulate said consolidated information elements via said Meta Window user interface; and
transferring said manipulated information elements to said destination computer resource upon user command.

2. The method as set forth in claim 1 wherein said step of designating two or more computer resources further comprises performing a user interface control action selected from the group of locking a user interface to said designated computer resources, minimizing a user interface to said designated computer resources, and hiding a user interface to said designated computer resource.

3. The method as set forth in claim 1 wherein said step of consolidating all information elements from said plurality of source computer resources into said Meta Window further comprises providing a user-interpretable indication of groups of information elements respective of their source computer resource.

4. The method as set forth in claim 3 wherein said step of providing a user-interpretable indication of groups of information elements respective of their source computer resource comprises providing a graphical line encompassing each group of information elements.

5. The method as set forth in claim 1 wherein said step of consolidating all information elements from said plurality of source computer resources into said Meta Window further comprises providing a user-interpretable indication of the source computer resource for each information element.

6. The method as set forth in claim 5 wherein said step of providing a user-interpretable indication of the source computer resource for each information element comprises providing an indication selected from the group of a file name, a file and path name combination, a network address, an Internet address, a server name, a drive name, and folder name.

7. The method as set forth in claim 1 further comprising the steps of:
tracing the source of consolidated information elements;
providing a user-operable refresh option to update all information elements;
responsive to operation of said refresh option, retrieving current information elements from said traced sources;
re-consolidating said retrieved current information elements; and
presenting said re-consolidated information elements for manipulation by said user in said Meta Window user interface.

8. The method as set forth in claim 1 further comprising the steps of:
creating a “Do list” which records each manipulation of said information elements by a user via said Meta Window user interface;
providing a user-operable undo option selectable for one or more entries in said “Do list”; and
responsive to operation of said undo option, reversing a change as recorded by a selected entry in said “Do list”.

9. The method as set forth in claim 1 further comprising the steps of:
providing a plurality of list entries or icons, each of which represent a computer resource;
providing a list entry or icon representing said Meta Window; and
responsive to a user action of moving a computer resource list entry or icon onto said Meta Window list entry or icon, designating said computer resource represented by the moved list entry or icon as a source computer resource such that all information elements related to said source computer resource are consolidated into said Meta Window.

10. A computer readable medium encoded with software for transferring content from a plurality of source computer resources to a destination computer resource, each computer resource having one or more information elements, the software performing the steps of:
designating of two or more computer resources as source computer resources;
responsive to said designation of two or more source computer resources, providing a Meta Window having a user interface;
consolidating all information elements from said plurality of source computer resources into said Meta Window;
allowing a user to manipulate said consolidated information elements via said Meta Window user interface; and
transferring said manipulated information elements to said destination computer resource upon user command.

11. The medium as set forth in claim 10 wherein said software for designating two or more computer resources further comprises software for performing a user interface control action selected from the group of locking a user interface to said designated computer resources, minimizing a user interface to
said designated computer resources, and hiding a user interface to said designated computer resource.

12. The medium as set forth in claim 10 wherein said software for consolidating all information elements from said plurality of source computer resources into said Meta Window further comprises software for providing a user-interpretable indication of groups of information elements respective of their source computer resource.

13. The medium as set forth in claim 12 wherein said software for providing a user-interpretable indication of groups of information elements respective of their source computer resource comprises software for providing a graphical line encompassing each group of information elements.

14. The medium as set forth in claim 10 wherein said software for consolidating all information elements from said plurality of source computer resources into said Meta Window further comprises software for providing a user-interpretable indication of the source computer resource for each information element.

15. The medium as set forth in claim 14 wherein said software for providing a user-interpretable indication of the source computer resource for each information element comprises software for providing an indication selected from the group of a file name, a file and path name combination, a network address, an Internet address, a server name, a drive name, and folder name.

16. The medium as set forth in claim 10 further comprising software for performing the steps of:
tracing the source of consolidated information elements;
providing a user-operable refresh option to update all information elements;
responsive to operation of said refresh option, retrieving current information elements from said traced sources;
re-consolidating said retrieved current information elements; and
presenting said re-consolidated information elements for manipulation by said user in said Meta Window user interface.

17. The medium as set forth in claim 10 further comprising software for performing the steps of:
creating a “Do list” which records each manipulation of said information elements by a user via said Meta Window user interface;
providing a user-operable undo option selectable for one or more entries in said “Do list”; and
responsive to operation of said undo option, reversing a change as recorded by a selected entry in said “Do list”.

18. The medium as set forth in claim 10 further comprising software for performing the steps of:
providing a plurality of list entries or icons, each of which represent a computer resource;
providing a list entry or icon representing said Meta Window; and
responsive to a user action of moving a computer resource list entry or icon onto said Meta Window list entry or icon, designating said computer resource represented by the moved list entry or icon as a source computer resource such that all information elements related to said source computer resource are consolidated into said Meta Window.

19. A system for transferring content from a plurality of source computer resources to a destination computer resource, each computer resource comprising one or more information elements, the system comprising:
a means for designating two or more computer resources as source computer resources;
a Meta Window having a user interface, activated responsive to said designation of two or more source computer resources;
an information element consolidator configured to automatically consolidate all information elements from said plurality of source computer resources into said Meta Window;
means within said Meta Window for allowing a user to manipulate said consolidated information elements via said Meta Window user interface; and
an information transferor configured to transfer said manipulated information elements to said destination computer resource upon user command.

20. The system as set forth in claim 19 wherein said means for designating two or more source computer resources is further configured to control a user interface to said source computer resource using a control selected from the group of locking a user interface to said designated computer resources, minimizing a user interface to said designated computer resources, and hiding a user interface to said designated computer resource.

21. The system as set forth in claim 19 wherein said means for consolidating all information elements from said plurality of source computer resources into said Meta Window is further configured to provide a user-interpretable indication of groups of information elements respective of their source computer resource.

22. The system as set forth in claim 21 wherein said indication of groups of information elements comprises a graphical line encompassing each group of information elements.

23. The system as set forth in claim 19 wherein said means for consolidating all information elements from said plurality of source computer resources into
said Meta Window further is further configured to provide a user-interpretable indication of the source computer resource for each information element.

24. The system as set forth in claim 23 wherein said user-interpretable indication of the source computer resource for each information element comprises an indication selected from the group of a file name, a file and path name combination, a network address, an Internet address, a server name, a drive name, and folder name.

25. The system as set forth in claim 19 further comprising:
a source trace of said consolidated information elements;
a user-operable refresh option to update all information elements; and
an information elements retriever configured to retrieve and re-consolidate current information elements from said source trace responsive to operation of said refresh option.

26. The system as set forth in claim 19 further comprising:
a “Do list” created in a manner to record each user manipulation of said information elements via said Meta Window user interface;
a user-operable undo option selectable for one or more entries in said “Do list”; and
an operation reverser configured to reverse a change as recorded by a selected entry in said “Do list” responsive to operation of said undo option.

27. The system as set forth in claim 19 further comprising:
a plurality of list entries or icons, each of which represent a computer resource;
a list entry or icon representing said Meta Window; and
an automatice source designator configured to, responsive to a user action of moving a computer resource list entry or icon onto said Meta Window list entry or icon, designate said computer resource represented by the moved list entry or icon as a source computer resource such that all information elements related to said source computer resource are consolidated into said Meta Window.
